(19) United States
(12) Patent Application Publication
(10) Pub. No.: US 2025/0293250 A1
(43) Pub. Date: Sep. 18, 2025

(54) Lithium Metal Oxide Based Cathode Chemistries for Lithium Batteries

(71) Applicant: Nissan North America, Inc., Franklin, TN (US)

(72) Inventors: Simran Kumari, Los Angeles, CA (US); Balachandran Gadaguntla Radhakrishnan, San Jose, CA (US); Masanobu Uchimura, Palo Alto, CA (US); Shigemasa Kuwata, Palo Alto, CA (US); Manas Likhit Holekevi Chandrappa, Sunnyvale, CA (US); Albert Xiao, Yokohama (JP); Koichiro Aotani, Fujisawa (JP)

(21) Appl. No.: 18/608,447

(22) Filed: Mar. 18, 2024

(51) Int. Cl. H01M 4/505; H01M 4/02; H01M 4/38; H01M 4/86; H01M 10/0525

(52) U.S. Cl. CPC H01M 4/505; H01M 4/382; H01M 10/0525; H01M 2004/028; H01M 2004/8684

(57) ABSTRACT

A lithium battery cell has an anode having anode active material, an electrolyte, and a cathode comprising cathode active material having the following composition:

LiₓM1_{y}M2_{z}Oₚ

wherein M1 and M2 are different from each other and each selected from Mn, Fe and V; 6≤x≤64; 1≤y≤35; 1≤z≤35; and 16≤p≤100.

### TECHNICAL FIELD

This disclosure pertains to lithium batteries featuring cathode chemistries based on oxides, utilizing combinations of two metals chosen from manganese (Mn), iron (Fe), and vanadium (V).

### BACKGROUND

Advances have been made toward high energy density batteries, using various anode materials in lithium-ion batteries, lithium metal batteries and all-solid-state batteries (ASSBs), together referred to as lithium batteries. Discovery of new materials and understanding the relationship between their structure, composition, physical properties, and battery performance has advanced the field. However, even with these advances, batteries remain limited by the underlying choice of materials and electrochemistry. Among the components in lithium batteries, the cathode active material may limit the energy density and dominates the battery cost.

### SUMMARY

Disclosed herein are implementations of lithium oxide cathode materials formulated with a combination of two of Mn, Fe and V. The disclosed ternary lithium metal oxides with two of Mn, Fe and V result in high stability, desired theoretical capacity, low lithium migration barriers and low band gap. The ternary nature results in highly stable chemistries.

One implementation of a lithium battery cell as disclosed herein comprises an anode having anode active material, an electrolyte, and a cathode comprising cathode active material having the following composition:

LiₓM1_{y}M2_{z}Oₚ

wherein M1 and M2 are different from each other and each selected from Mn, Fe and V; 6≤x≤64; 1≤y≤35; 1≤z≤35; and 16≤p≤100.

Another implementation is a cathode active material for a lithium battery cell, comprising cathode active material having the following composition:

LiₓM1_{y}M2_{z}Oₚ

wherein M1 and M2 are different from each other and each selected from Mn, Fe and V; 6≤x ≤64; 1≤y≤35; 1≤z≤35; and 16≤p≤100.

M1 and M2 may be Mn and Fe, respectively.

The cathode active material may be one or a combination of Li₄₀MnFe₇O₃₂, Li₂₀MnFe₃O₁₆, Li₈Mn₃FeO₁₂, Li₆₄Mn₉Fe₂₃O₉₆, and Li₆₄Mn₅(Fe₉O₃₂).

M1 and M2 may be V and Fe, respectively.

The cathode active material may be one or a combination of Li₄₀VFe₇O₃₂ and Li₄₀V₃Fe₅O₃₂.

M1 and M2 may be Mn and V, respectively.

The cathode active material may be Li₁₆Mn₇VO₂₄.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-section schematic view of a lithium battery cell as disclosed herein.

### DETAILED DESCRIPTION

A battery's voltage and capacity, and thus the battery's output, can be optimized by, at least in part, increasing the potential difference between the anode and cathode, reducing the mass and volume of active material necessary, and reducing loss of active materials by reducing oxidation or reduction reactions.

In lithium batteries, electrode materials facilitate the reversible insertion of ions through ion-conductive crystalline structures, enabling efficient uptake and release of lithium ions by the cathode during charge and discharge cycles. Conventional cathode active material consists of transition metal oxides or phosphates, which undergo low-volume expansion and contraction during lithiation and delithiation. Conventional cathode materials typically use one or a combination of cobalt (Co), nickel (Ni), Mn and aluminum (Al).

Due to the cost and depleting reserves of cobalt, cathode active materials with diminished mole ratios of cobalt, or no cobalt altogether, have been developed. Nickel-rich NMC cathode active materials often have the formula LiNiₓM₁₋ₓO₂, where x≥0.6 and M=Mn, Co, and sometimes Al. But it suffers from low cycle stability due to the many degradation mechanisms available, including irreversible structural transformation, thermal degradation, and formation of a cathode electrolyte interphase (CEI) layer. The use of nickel alone, such as in LiNiO₂, may suffer from structural degradation upon lithiation and delithiation. LiNiO₂ is reactive to the electrolyte when charged to high voltages (>4 V vs Li) due to the oxidizing power of the Ni⁴⁺ in the delithiated state.

Lithium batteries may also use sulfur-based cathode active materials, which can have higher energy density than those with transition metal oxide-based cathode active materials. Sulfur is also a lower cost material when compared to some transition metal oxide-based materials, such as those materials using cobalt. However, lithium batteries using sulfur-based cathode active materials have drawbacks such as poor discharge and poor stability.

MnO₂ exhibits a combination of moderate capacity, moderate voltage and low cost. However, MnO₂ falls short of energy density targets. Fe and V are abundant and lower in cost, and produce redox activity in the relevant voltage range of 4.0 to 2.0 V vs Li+/Li. The cathode materials disclosed herein meet the requisite energy densities using a combination of two of Mn, Fe and V. The disclosed ternary metal cathode chemistries are lithium metal oxides with two of Mn, Fe and V, resulting in high stability, desired theoretical capacity, low lithium migration barriers and low band gap. The ternary nature results in highly stable chemistries.

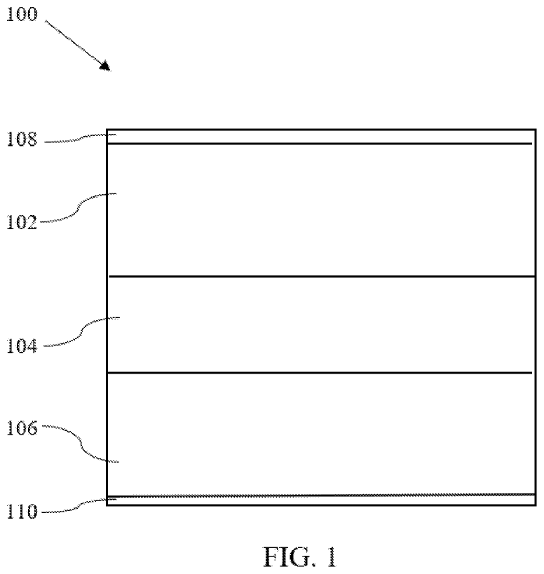

A lithium battery cell 100 is illustrated schematically in cross-section in FIG. 1. The lithium battery cell 100 of FIG. 1 is configured as a layered battery cell that includes as active layers a cathode active material layer 102 having the ternary metal cathode chemistries as described herein, an electrolyte 104, and an anode active material layer 106. In some embodiments, such as lithium batteries using a liquid or gel electrolyte, the lithium battery cell 100 may include a separator interposed between the cathode active material layer 102 and the anode active material layer 106. In addition to the active layers, the lithium battery cell 100 of FIG. 1 may include a cathode current collector 108 and an anode current collector 110, configured such that the active layers are interposed between the anode current collector 110 and the cathode current collector 108. In such a configuration, the cathode current collector 108 is adjacent to the cathode active material layer 102, and the anode current collector 110 is adjacent to the anode active material layer 106. A lithium battery can be comprised of multiple lithium battery cells 100.

The anode active material in the anode active material layer 106 of a lithium metal battery can be a layer of elemental lithium metal, a layer of a lithium compound(s) or a layer of doped lithium. The anode active material in the anode active material layer 106 of a lithium-ion battery can be a layer graphite or a silicon-based material. Other anode active materials known to those skilled in the art can be used. The anode current collector 110 can be, as a non-limiting example, a sheet or foil of copper, nickel, a copper-nickel alloy, carbon paper, or graphene paper.

In lithium batteries, the electrolyte 104 may include a liquid electrolyte, a polymer ionic liquid, a gel electrolyte, or a combination thereof. The electrolyte can be an ionic liquid-based electrolyte mixed with a lithium salt. The ionic liquid may be, for example, at least one selected from N-Propyl-N-methylpyrrolidinium bis(flurosulfonyl)imide, N-methyl-N-propylpyrrolidinium bis(trifluoromethanesulfonyl)imide, N-butyl-N-methylpyrrolidinium bis(trifluoromethylsulfonyl)imide, 1-butyl-3-methylimidazolium bis(trifluoromethylsulfonyl)imide, and 1-ethyl-3-methylimidazolium bis(trifluoromethylsulfonyl)imide. The salt can be or include, for example, a fluorosulfonyl (FS0) group, e.g., lithium bisfluorosulfonylimide (LiN(FS0₂)₂, (LiFSI), LiN(FS0₂)₂, LiN(FS0₂)(CF₃S0₂), LiN(FS0₂)(C₂F₅S0₂). In some embodiments, the electrolyte is or includes a cyclic carbonate (e.g., ethylene carbonate (EC) or propylene carbonate, a cyclic ether such as tetrahydrofuran (THF) or tetrahydropyran (TH), a glyme such as dimethoxyethane (DME) or diethoxyethane, an ether such as diethylether (DEE) or methylbutylether (MBE), their derivatives, and any combinations and mixtures thereof. Where a separator is used, such as with a liquid or gel electrolyte, the separator can be a polyolefine or a polyethylene, as non-limiting examples.

In ASSBs, the electrolyte 104 is solid. The solid electrolyte can be, as non-limiting examples, sulfide compounds (e.g. Argyrodite, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO).

The cathode active material layer 102 comprises a cathode active material having the following composition:

LiₓM1_{y}M2_{z}Oₚ

wherein M1 and M2 are different from each other and each selected from Mn, Fe and V; 6≤x≤64; 1≤y≤35; 1≤z≤35; and 16≤p≤100.

The disclosed ternary metal cathode active material can be used in a lithium-ion battery, a lithium metal battery or an ASSB. A disclosed ternary metal cathode active material may be the only cathode active material in the cathode active material layer 102 or can be combined with others of the disclosed ternary metal cathode active material, such that the cathode active material consists of the combination of disclosed ternary metal cathode active materials. The disclosed ternary metal cathode active material or combination of disclosed ternary metal cathode active materials may be mixed with one or more conventional cathode materials. The cathode active material layer 102 may also include binders and optionally conductive fillers such as carbon black.

M1 and M2 may be Mn and Fe, respectively. Examples of the cathode active material may be one or a combination of Li₄₀MnFe₇O₃₂, Li₂₀MnFe₃O₁₆, Li₈Mn₃FeO₁₂, Li₆₄Mn₉Fe₂₃O₉₆, and Li₆₄Mn₅(Fe₉O₃₂).

M1 and M2 may be V and Fe, respectively. Examples of the cathode active material may be one or a combination of Li₄₀VFe₇O₃₂ and Li₄₀V₃Fe₅O₃₂.

M1 and M2 may be Mn and V, respectively. An example of the cathode active material may be Li₁₆Mn₇VO₂₄.

The ternary metal cathode active materials disclosed here offer lithium battery cells enhanced stability owing to the inclusion of lithium metal oxide where the metals could be a combination of two metals chosen from manganese (Mn), iron (Fe), and vanadium (V). Additionally, these materials exhibit low barriers to lithium migration.

Ionic conductivity serves as the primary measure for assessing the ease of ionic migration within solid materials. While crystal structure significantly impacts ionic conductivity, the microstructure resulting from material processing also plays a crucial role. To ensure a standardized evaluation independent of processing conditions, the lithium-ion migration barrier serves as a metric for assessing the ionic migration of lithium compounds. The ion-conducting materials discussed here demonstrate a low migration barrier, estimated at 0.6 eV or less.

The disclosed ternary metal cathode active materials provide lithium battery cells with theoretical capacities greater than 200 mAh/g. The disclosed ternary metal cathode active materials also have a low band gap of between about 2 eV to 4 eV.

Unless otherwise defined, all technical and scientific terms used have the same meaning as commonly understood by one of ordinary skill in the art to which the claimed subject matter belongs. The terminology used in this description is for describing particular embodiments only and is not intended to be limiting. As used in the specification and appended claims, the singular forms “a,” “an,” and “the” are intended to include the plural forms as well, unless the context clearly indicates otherwise.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lithium battery cell, comprising:
an anode having anode active material;
an electrolyte; and
a cathode comprising cathode active material having the following composition:
LiₓM1_{y}M2_{z}Oₚ
wherein M1 and M2 are different from each other and each selected from Mn, Fe and V; 6≤x≤64; 1≤y≤35; 1≤z≤35; and 16≤p≤100.

2. The lithium battery cell of claim 1, wherein M1 and M2 are Mn and Fe, respectively.

3. The lithium battery cell of claim 2, wherein the cathode active material is one or a combination of Li₄₀MnFe₇O₃₂, Li₂₀MnFe₃O₁₆, Li₈Mn₃FeO₁₂, Li₆₄Mn₉Fe₂₃O₉₆, and Li₆₄Mn₅(Fe₉O₃₂).

4. The lithium battery cell of claim 1, wherein M1 and M2 are V and Fe, respectively.

5. The lithium battery cell of claim 4, wherein the cathode active material is one or a combination of Li₄₀VFe₇O₃₂ and Li₄₀V₃Fe₅O₃₂.

6. The lithium battery cell of claim 1, wherein M1 and M2 are Mn and V, respectively.

7. The lithium battery cell of claim 6, wherein the cathode active material is Li₁₆Mn₇VO₂₄.

8. The lithium battery cell of claim 1, wherein the anode active material is graphite.

9. The lithium battery cell of claim 1, wherein the anode active material is lithium metal.

10. The lithium battery cell of claim 1, wherein the anode active material is a silicon-based material.

11. A cathode active material for a lithium battery cell, comprising:
cathode active material having the following composition:
LiₓM1_{y}M2_{z}Oₚ
wherein M1 and M2 are different from each other and each selected from Mn, Fe and V; 6 ≤x≤64; 1≤y≤35; 1≤z≤35; and 16≤p≤100.

12. The cathode active material of claim 11, wherein M1 and M2 are Mn and Fe, respectively.

13. The cathode active material of claim 12, being one or a combination of Li₄₀MnFe₇O₃₂, Li₂₀MnFe₃O₁₆, Li₈Mn₃FeO₁₂, Li₆₄Mn₉Fe₂₃O₉₆, and Li₆₄Mn₅(Fe₉O₃₂).

14. The cathode active material of claim 11, wherein M1 and M2 are V and Fe, respectively.

15. The cathode active material of claim 14, being one or a combination of Li₄₀VFe₇O₃₂ and Li₄₀V₃Fe₅O₃₂.

16. The cathode active material of claim 11, wherein M1 and M2 are Mn and V, respectively.

17. The cathode active material of claim 16, being Li₁₆Mn₇VO₂₄.
